(19) United States
(12) Patent Application Publication
(10) Pub. No.: US 2016/0072377 A1
(43) Pub. Date: Mar. 10, 2016

(54) POWER SUPPLY AND APPARATUS INCLUDING THE SAME

(71) Applicant: Samsung Electro-Mechanics Co., Ltd., Suwon-si (KR)

(72) Inventors: Sung Hun OH, Suwon-si (KR); Won Young LEE, Suwon-si (KR); Hee Seo LEE, Suwon-si (KR)

(73) Assignee: SAMSUNG ELECTRO-MECHANICS CO., LTD., Suwon-si (KR)

(21) Appl. No.: 14/819,525

(22) Filed: Aug. 6, 2015

(30) Foreign Application Priority Data
Sep. 5, 2014 (KR) 10-2014-0119200
Dec. 10, 2014 (KR) 10-2014-0177189

(51) Int. Cl. H02M 1/42

(52) U.S. Cl. CPC H02M 1/42

(57) ABSTRACT

A power supply may include a control signal generating unit outputting a control signal in response to a load information signal input thereto, a controlling unit activating and outputting a first gate signal or activating and outputting first and second gate signals in response to the control signal, a first power factor correction unit operating in response to the first gate signal, and a second power factor correction unit operating in response to the second gate signal.

### CROSS-REFERENCE TO RELATED APPLICATION

This application claims the priority and benefit of Korean Patent Application Nos. 10-2014-0119200 filed on Sep. 5, 2014 and 10-2014-0177189 filed on Dec. 10, 2014, with the Korean Intellectual Property Office, the disclosures of which are incorporated herein by reference.

### BACKGROUND

The present disclosure relates to a power supply including a plurality of power factor correction circuits and an apparatus including the same.

Generally, apparatuses including electronic elements and performing predetermined functions require a power supply receiving externally-supplied alternating current (AC) power and supplying at least one driving power required by the apparatuses thereto. Here, in a case in which power having a predetermined magnitude or more is required, the power supply includes a power factor correction unit including a power factor correction circuit.

In some cases, a power supply includes two or more power factor correction units to efficiently control a higher amount of output power. However, in such a case, when the two or more power factor correction units are not appropriately controlled, power consumption may be unnecessarily increased, the amount of heat generated from coils configuring the power factor correction units may be increased, or other problems may occur.

### RELATED ART DOCUMENT

(Patent Document 1) Korean Patent Laid-Open Publication No. 10-2013-0072526

(Patent Document 2) Korean Patent Laid-Open Publication No. 10-2009-0058246

### SUMMARY

An aspect of the present disclosure may provide a power supply controlling a plurality of power factor correction units, each including a power factor correction circuit, in response to a load information signal input thereto.

An aspect of the present disclosure may provide an apparatus including a power supply controlling a plurality of power factor correction units, each including a power factor correction circuit, in response to a load information signal input thereto.

According to an aspect of the present disclosure, a power supply may include a control signal generating unit outputting a control signal in response to a load information signal input externally, a controlling unit activating and outputting a first gate signal or activating and outputting the first gate signal and a second gate signal in response to the control signal, a first power factor correction unit operating in response to the first gate signal, and a second power factor correction unit operating in response to the second gate signal.

According to another aspect of the present disclosure, an apparatus may include a power supply including a plurality of power factor correction units of which operations are respectively controlled depending on a load information signal, receiving external power from an external power source, and outputting one or more levels of driving power, and an electronic device receiving the one or more levels of driving power and driven by the one or more levels of driving power and outputting the load information signal containing information about power required for driving the electronic device.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram illustrating a configuration of an apparatus including a power supply according to an exemplary embodiment in the present disclosure;

FIG. 2 is a view illustrating a configuration of the power supply according to the exemplary embodiment in the present disclosure;

FIG. 3 is a view illustrating a configuration of a control signal generating unit of the power supply according to the exemplary embodiment in the present disclosure illustrated in FIG. 2;

FIG. 4 is a view illustrating a configuration of a power factor-corrected power generating unit of the power supply according to the exemplary embodiment in the present disclosure illustrated in FIG. 2; and

FIG. 5 is a timing diagram illustrating an operation of a controlling unit of the power factor-corrected power generating unit illustrated in FIG. 4.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

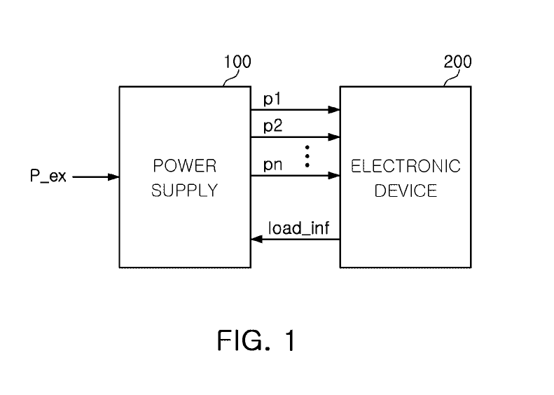

FIG. 1 is a block diagram illustrating a configuration of an apparatus including a power supply 100 according to an exemplary embodiment in the present disclosure. The apparatus may include the power supply 100 and an electronic device 200.

Respective functions of blocks illustrated in FIG. 1 will be described below.

The power supply 100 may receive external power P_ex from an external power source and output a plurality of levels of driving power p1, p2, . . . , pn. In a case in which the electronic device 200 is a light emitting diode television (LED TV), the plurality of levels of driving power p1, p2, . . . , pn may be a power level for driving a main board, a power level for driving a speaker, a power level for driving an LED, a backlight light source, and the like. Although not illustrated in FIG. 1, the power supply 100 may additionally output standby power. The plurality of levels of driving power p1, p2, . . . , pn may have different voltage levels, respectively. For example, the power level for driving the main board may be 12V, the power level for driving the speaker may be 12V or 18V, and the standby power may be 3.3V. The external power P_ex may be commercially-available AC power.

The power supply 100 may include a plurality of power factor correction units (not illustrated), each of which may include a power factor correction circuit. Respective operations of the plurality of power factor correction units of the power supply 100 may be controlled depending on a load information signal load_inf input from the electronic device 200. In addition, the plurality of power factor correction units of the power supply 100 may be controlled in an interleaved scheme.

The electronic device 200 may receive the plurality of levels of driving power p1, p2, . . . , pn from the power supply 100 to perform a predetermined operation. For example, in the case in which the electronic device 200 is an LED TV, the electronic device 200 may receive the plurality of levels of driving power p1, p2, . . . , pn to display an image and output audio. In addition, the electronic device 200 may output the load information signal load_inf indicating a level of power required for performing the predetermined operation. That is, the load information signal load_inf may be a signal indicating whether the electronic device 200 is under a light load condition or a heavy load condition. For example, in the case in which the electronic device 200 is an LED TV, the load information signal load_inf may be a signal for turning a backlight light source on.

Although not illustrated in FIG. 1, the electronic device 200 may additionally output a preparation signal indicating a start of an operation of the electronic device 200. In this case, the power supply 100 may start an operation in response to the preparation signal.

In addition, although a case in which the apparatus according to the exemplary embodiment in the present disclosure includes the electronic device is illustrated in FIG. 1, any type of device able to receive driving power from a power supply and output a load_inf ormation signal may be used as the electronic device.

In addition, although a case in which the power supply 100 outputs a plurality of levels of driving power is illustrated in FIG. 1, only a single level of driving power may be output by the power supply 100.

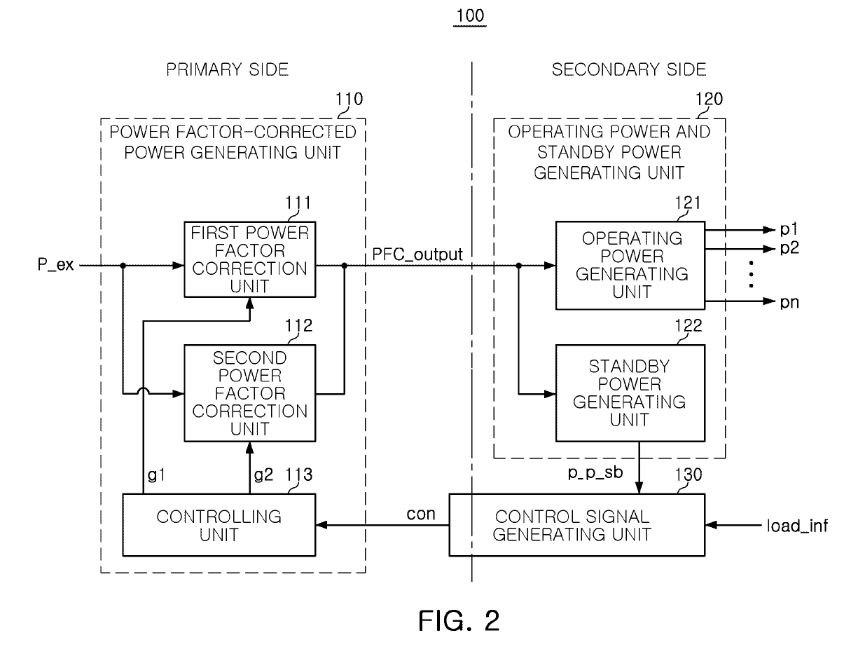

FIG. 2 is a view illustrating a configuration of the power supply 100 according to the exemplary embodiment in the present disclosure. The power supply 100 according to the exemplary embodiment in the present disclosure may include a power factor-corrected power generating unit 110, an operating power and standby power generating unit 120, and a control signal generating unit 130. The power factor-corrected power generating unit 110 may include a first power factor correction unit 111, a second power factor correction unit 112, and a controlling unit 113, and the operating power and standby power generating unit 120 may include an operating power generating unit 121 and a standby power generating unit 122.

Respective functions of blocks illustrated in FIG. 2 will be described below.

The power factor-corrected power generating unit 110 may receive external power P ex, and output power factor corrected power PFC_output of which a power factor is improved, in response to a control signal con. The power factor-corrected power generating unit 110 may allow phases of a voltage and a current of the power factor corrected power PFC_output to be the same as each other, thereby improving a power factor of the output power.

The first power factor correction unit 111 may operate in response to a first gate signal g1. In addition, the second power factor correction unit 112 may operate in response to a second gate signal g2.

The first power factor correction unit 111 and the second power factor correction unit 112 may respectively receive the external power P_ex (or power generated by rectifying the external power P_ex) and output power of which a power factor is corrected. The power factor corrected power PFC_output may be power corresponding to the sum of output power of the first power factor correction unit 111 and output power of the second power factor correction unit 112.

The controlling unit 113 may output the first gate signal g1 for operating the first power factor correction unit 111 or output the first gate signal g1 and second gate signal and g2 for operating both of the first power factor correction unit 111 and the second power factor correction unit 112, in response to the control signal con. For example, in a case in which the electronic device 200 (See FIG. 1) is under the light load condition, the controlling unit 113 may activate and output only the first gate signal g1 in order to operate only the first power factor correction unit 111 in response to the control signal con, and in a case in which the electronic device 200 (See FIG. 1) is under the heavy load condition, the controlling unit 113 may activate and output both of the first gate signal g1 and the second gate signal g2 in order to operate both of the first power factor correction unit 111 and the second power factor correction unit 112 in response to the control signal con.

The operating power and standby power generating unit 120 may receive the power factor corrected power PFC_output and output a plurality of levels of operating power p1, p2, . . . , pn and standby power p_sb. The operating power generating unit 121 may receive the power factor corrected power PFC_output and output the plurality of levels of operating power p1, p2, . . . , pn, and the standby power generating unit 122 may receive the power factor corrected power PFC_output and output the standby power p_sb.

The control signal generating unit 130 may output the control signal con in response to the load_inf ormation signal load_inf input thereto.

The power factor-corrected power generating unit 110 may be included in a primary circuit of the power supply 100, and the operating power and standby power generating unit 120 may be included in a secondary circuit of the power supply 100. The control signal generating unit 130 may transfer the load information signal load_inf input from the secondary circuit of the power supply 100 to the primary circuit of the power supply 100 to output the control signal con. The primary circuit of the power supply 100 may be a circuit to which the external power P_ex is input, and the secondary circuit of the power supply 100 may be a circuit supplying power to the electronic device 200 (See FIG. 1).

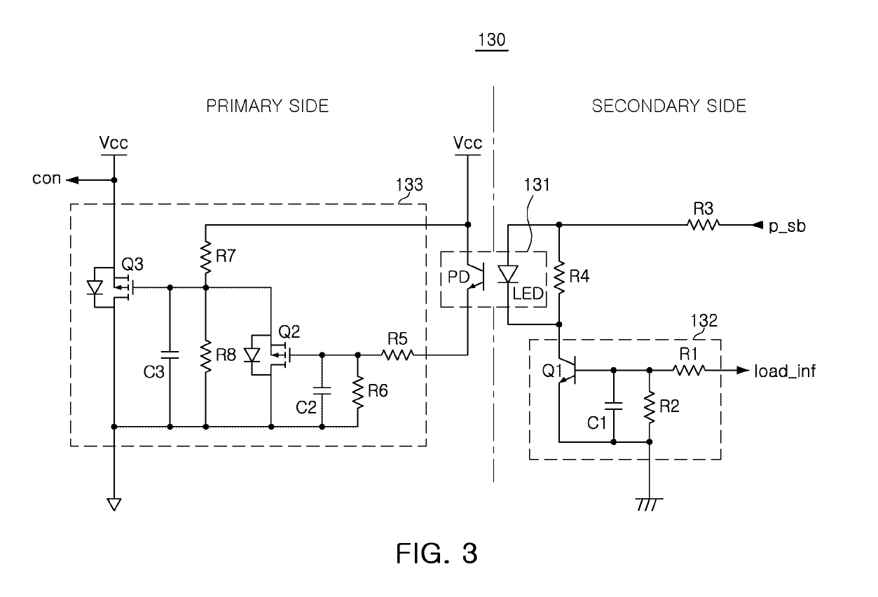

FIG. 3 is a view illustrating a configuration of a control signal generating unit 130 of the power supply 100 according to the exemplary embodiment in the present disclosure illustrated in FIG. 2. The control signal generating unit 130 may include a photo coupler 131, a first switching unit 132, and a second switching unit 133.

The photo coupler 131 may include a photo detector PD having one end connected to a terminal to which direct current (DC) power Vcc is applied, and a light emitting diode LED having one end connected to a terminal to which the standby power p_sb is applied.

The first switching unit 132 may include a transistor Q1 having a gate terminal to which the load information signal load_inf is applied and connected between the other end of the light emitting diode LED and a ground. The first switching unit 132 may further include a capacitor C1 connected between a gate of the transistor Q1 and the ground, a resistor R2 connected to the capacitor C1 in parallel, and a resistor R1 connected between the gate of the transistor Q1 and the terminal to which the load information signal load_inf is applied.

The second switching unit 133 may include a resistor

R5 having one end connected to the other end of the photo detector PD of the photo coupler 131, a resistor R6 connected between the other end of the resistor R5 and a ground, a resistor R7 having one end connected to the terminal to which the DC power Vcc is applied, a resistor R8 connected between the other end of the resistor R7 and the ground, a transistor Q2 having a gate connected to the other end of the resistor R5 and connected between the other end of the resistor R7 and the ground, and a transistor Q3 having a gate connected to the other end of the resistor R7 and connected between the terminal to which the DC power Vcc is applied and the ground. The second switching unit 133 may further include a capacitor C2 connected between the gate of the transistor Q2 and the ground, and a capacitor C3 connected between the gate of the transistor Q3 and the ground.

The first switching unit 132 may be included in the secondary circuit of the power supply 100 (See FIG. 2), and the second switching unit 133 may be included in the primary circuit of the power supply 100 (See FIG. 2).

The DC power Vcc may be generated using the external power P_ex. For example, the power supply 100 (See FIG. 2) according to the exemplary embodiment in the present disclosure may further include a DC power generating unit receiving the external power P_ex and generating the DC power Vcc.

Respective functions of blocks illustrated in FIG. 3 will be described below.

The first switching unit 132 may drive the light emitting diode LED of the photo coupler 131 in response to the load_inf ormation signal load_inf.

The photo coupler 131 may transfer the load information signal load_inf input to the secondary circuit of the power supply 100 (See FIG. 2) to the primary circuit of the power supply 100 (See FIG. 2).

The second switching unit 133 may output the control signal con in response to the load information signal load_inf transferred by the photo coupler 131.

An operation of the control signal generating unit 130 of the power supply according to the exemplary embodiment in the present disclosure illustrated in FIG. 3 will be described below.

The load information signal load_inf may be a low-level signal in the case in which the electronic device 200 (See FIG. 1) is under the light load condition and may be a high-level signal in the case in which the electronic device 200 (See FIG. 1) is under the heavy load condition. In the case in which the electronic device 200 (See FIG. 1) is the LED TV, the load information signal load_inf may be a signal for turning the LED, a backlight light source, on. In a case in which the LED, the backlight light source, is turned off, the load information signal load_inf may be a low-level signal, and in a case in which the LED, the backlight light source, is turned on, the load information signal load_inf may be a high-level signal.

In a case in which the load information signal load_inf is the low-level signal, the transistor Q1 may be turned off, such that the photo coupler 131 may be turned off. Since the photo coupler 131 is in a turned-off state, the transistor Q2 may be in a turned-off state, and the transistor Q3 may be turned on. As a result, the control signal con having a voltage level of the ground may be output.

In a case in which the load_inf ormation signal load_inf is the high-level signal, the transistor Q1 may be turned on, such that the photo coupler 131 may be turned on. Since the photo coupler 131 is in a turned-on state, the transistor Q2 may be in a turned-on state, and the transistor Q3 may be turned off. As a result, the control signal con having a voltage level of a ground voltage may be output.

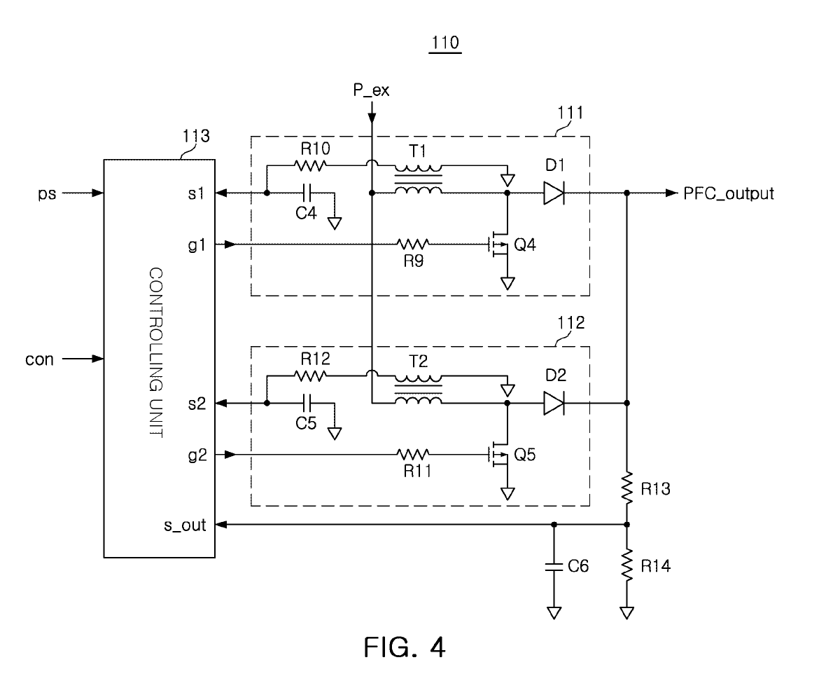

FIG. 4 is a view illustrating a configuration of a power factor-corrected power generating unit 110 of the power supply according to the exemplary embodiment in the present disclosure illustrated in FIG. 2. The power factor-corrected power generating unit 110 may include a first power factor correction unit 111 including a power factor correction circuit containing T1, R9, and Q4, a second power factor correction unit 112 including a power factor correction circuit containing T2, R11, and Q5, a controlling unit 113, and a rectifying unit 114.

Respective functions of blocks illustrated in FIG. 4 will be described below.

The controlling unit 113 may activate and output a first gate signal g1 or may activate and output the first gate signal g1 and a second gate signal g2, in response to a control signal con. In detail, the controlling unit 113 may activate and output only the first gate signal g1 in a case in which the control signal con has a voltage level of the ground, and may activate and output both of the first gate signal g1 and the second gate signal g2 in a case in which the control signal con has a voltage level of the DC power Vcc.

As described above, the electronic device 200 (See FIG. 1) may additionally output a preparation signal indicating a start of an operation of the electronic device 200 (See FIG. 1). In this case, the controlling unit 113 may operate in response to an enable signal en generated in response to the preparation signal. The enable signal en may be generated in response to the preparation signal by the same method as a method of generating the control signal con.

The first power factor correction unit 111 may include a transistor Q4 turned on or off in response to the first gate signal g1, and a power factor of the external power P_ex may be improved by an operation of the transistor Q4.

The second power factor correction unit 112 may include a transistor Q5 turned on or off in response to the second gate signal g2, and a power factor of the external power P_ex may be improved by an operation of the transistor Q5.

The controlling unit 113 may receive a sensed signal s1 obtained by sensing a current level output from the first power factor correction unit 111 through a transformer T1, a resistor R10, and a capacitor C4, may receive a sensed signal s2 obtained by sensing a current level output from the second power factor correction unit 112 through a transformer T2, a resistor R12, and a capacitor C5, and may receive a sensed signal s_out obtained by sensing a voltage level of the power factor corrected power PFC_output through a resistor R13, a resistor R14, and a capacitor C6. In this case, the controlling unit 113 may output the first gate signal g1 and the second gate signal g2 in response to the sensed signals s1, s2, and s_out.

The controlling unit 113 may be implemented by one integrated circuit (IC) chip.

The rectifying unit 114 may include a bridge circuit, a smoothing capacitor, and the like, and rectify the external power P_ex to output the rectified power. The rectified power may be supplied to the first power factor correction unit 111 and the second power factor correction unit 112.

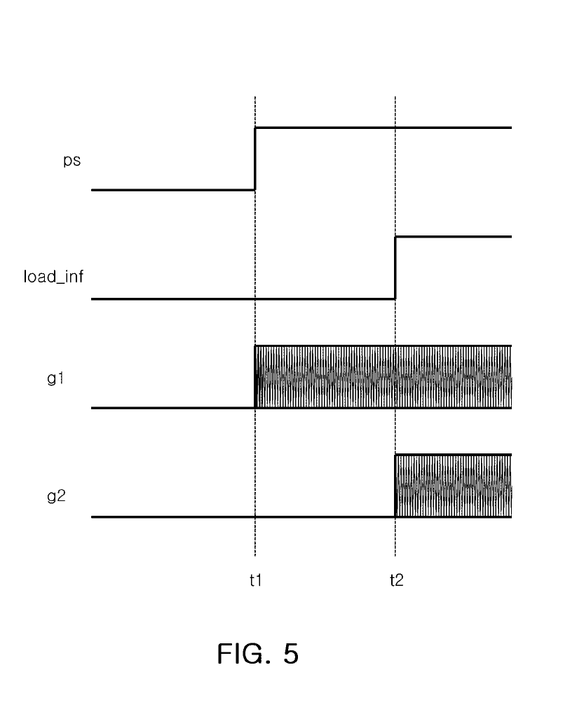

FIG. 5 is a timing diagram illustrating an operation of a controlling unit 113 of the power factor-corrected power generating unit 110 according to the exemplary embodiment in the present disclosure illustrated in FIG. 4. In FIG. 5, ps indicates the preparation signal output from the electronic device 200 (See FIG. 1), load_inf indicates the load information signal output from the electronic device 200 (See FIG. 1), and g1 and g2 indicate the first gate signal and the second gate signal output from the controlling unit 113 (See FIG. 4), respectively.

In a case in which both of the preparation signal ps and the load information signal load_inf are in low level states, both of the first gate signal g1 and the second gate signal g2 may be maintained in low level states (before t1). Thus, both of the first power factor correction unit 111 and the second power factor correction unit 112 (See FIG. 4) may not operate.

When the preparation signal ps reaches a high level, the enable signal en (See FIG. 4) may reach a high level, such that the controlling unit 113 may start to operate. Here, when the load information signal load_inf is in a low level state, the control signal con (See FIG. 4) may be in a low level state. In this case, only the first gate signal g1 may be activated and output (between t1 and t2). Thus, since only the first power factor correction unit 111 (See FIG. 4) may operate, power consumption may be decreased between t1 and t2.

Then, when the load information signal load_inf reaches a high level, the control signal con (See FIG. 4) may reach a high level. In this case, both of the first gate signal g1 and the second gate signal g2 may be activated and output (after t2). Thus, since both of the first power factor correction unit 111 and the second power factor correction unit 112 (See FIG. 4) may operate, heat generation, or the like, of coils and transistors of the first power factor correction unit 111 and the second power factor correction unit 112 (See FIG. 4) may be decreased.

Although not illustrated, both of the first gate signal g1 and the second gate signal g2 may be activated and output regardless of the load_inf ormation signal load_inf for a predetermined test time immediately after the preparation signal ps reaches the high level, in detail, immediately after a point in time t1, such that the controlling unit 113 may test an operation of the power factor-corrected power generating unit 110 (See FIG. 2).

As set forth above, in the power supply and the apparatus including the same according to an exemplary embodiment in the present disclosure, the plurality of power factor correction units including the power factor correction circuit are appropriately controlled, whereby power consumption may be decreased under a light load condition and the power supply and the apparatus including the same may stably operate without a problem such as heat generation, or the like, of the coil, even under a heavy load condition.

In the above exemplary embodiments, “controlling unit” can be implemented in many ways, such as program instructions for execution by a processor, as software modules, microcode, as computer program product on computer readable media, as logic circuits, as application specific integrated circuit, as firmware, etc. Further, embodiments of the invention can take the form of an entirely hardware embodiment, an entirely software embodiment or an embodiment containing both hardware and software elements.

While exemplary embodiments have been shown and described above, it will be apparent to those skilled in the art that modifications and variations could be made without departing from the scope of the present invention as defined by the appended claims.

What is claimed is:

1. A power supply comprising:
a control signal generating unit outputting a control signal in response to a load_inf ormation signal input externally;
a controlling unit activating and outputting a first gate signal or activating and outputting the first gate signal and a second gate signal in response to the control signal;
a first power factor correction unit operating in response to the first gate signal; and
a second power factor correction unit operating in response to the second gate signal.

2. The power supply of claim 1, wherein the controlling unit activates and outputs only the first gate signal when the load information signal indicates that an electronic device is under a light load condition, and activates and outputs the first gate signal and the second gate signal when the load information signal indicates that the electronic device is under a heavy load condition.

3. The power supply of claim 1, wherein the control signal generating unit includes:
a photo coupler including a photo detector and a light emitting diode;
a first switching unit driving the light emitting diode in response to the load information signal; and
a second switching unit outputting the control signal in response to an output signal from the photo detector.

4. The power supply of claim 3, wherein the first switching unit includes a transistor having a gate terminal to which the load information signal is applied and connected between the other end of the light emitting diode and a ground.

5. The power supply of claim 3, wherein the second switching unit includes:
a first transistor connected between a terminal to which direct current (DC) power is applied and a ground and outputting the control signal; and
a second transistor connected between a gate of the first transistor and the ground and having a gate terminal to which the output signal from the photo detector is applied.

6. The power supply of claim 1, wherein the first power factor correction unit includes a first transistor turned on or off in response to the first gate signal, and a power factor of external power is adjusted by an operation of the first transistor, and
the second power factor correction unit includes a second transistor turned on or off in response to the second gate signal, and a power factor of external power is adjusted by an operation of the second transistor.

7. The power supply of claim 6, further comprising:
an operating power generating unit receiving the power factor-corrected power and outputting one or more levels of operating power externally; and
a standby power generating unit receiving the power factor-corrected power and outputting standby power to the control signal generating unit.

8. An apparatus comprising:
a power supply including a plurality of power factor correction units of which operations are respectively controlled depending on a load_inf ormation signal, receiving external power, and outputting one or more levels of driving power; and
an electronic device receiving the one or more levels of driving power and driven by the one or more levels of driving power, and outputting the load_inf ormation signal containing information regarding power required for driving the electronic device.

9. The apparatus of claim 8, wherein the electronic device is a light emitting diode television (LED TV), and the load information signal is a signal for turning a backlight light source on.

10. The apparatus of claim 8, wherein the power supply includes:
a control signal generating unit outputting a control signal in response to the load information signal;
a controlling unit activating and outputting a first gate signal or activating and outputting the first gate signal and a second gate signal in response to the control signal;
a first power factor correction unit operating in response to the first gate signal to adjust a power factor of external power;
a second power factor correction unit operating in response to the second gate signal to adjust a power factor of external power;
a rectifying unit rectifying the external power and supplying the rectified power to the first power factor correction unit and the second power factor correction unit; and
an operating power generating unit receiving the power factor-corrected power and outputting one or more levels of operating power.

11. The apparatus of claim 10, wherein the control signal generating unit includes:
a photo coupler including a photo detector and a light emitting diode;
a first switching unit driving the light emitting diode in response to the load information signal; and
a second switching unit outputting the control signal in response to an output signal from the photo detector.

12. The apparatus of claim 11, wherein the first switching unit includes a transistor having a gate terminal to which the load information signal is applied and connected between the other end of the light emitting diode and a ground.

13. The apparatus of claim 11, wherein the second switching unit includes:
a first transistor connected between a terminal to which direct current power is applied and a ground and outputting the control signal; and
a second transistor connected between a gate of the first transistor and the ground and having a gate terminal to which the output signal of the photo detector is applied.

14. The apparatus of claim 10, wherein the electronic device additionally outputs a preparation signal indicating a start of an operation, and
the control signal generating unit additionally outputs an enable signal in response to the preparation signal.

15. The apparatus of claim 14, wherein the controlling unit activates and outputs only the first gate signal when the enable signal is activated and activates and outputs the first gate signal and the second gate signal when the control signal is activated.
